(19) United States
(12) Patent Application Publication
(10) Pub. No.: US 2013/0120724 A1
(43) Pub. Date: May 16, 2013

(54) Method for splitting a pattern for use in a multi-beamlet lithography apparatus

(71) Applicants: Marco Jan-Jaco WIELAND, Delft (NL); Joris Anne Henri VAN NIEUWSTADT, Utrecht (NL); Teunis VAN DE PEUT, Leusden (NL)

(72) Inventors: Marco Jan-Jaco WIELAND, Delft (NL); Joris Anne Henri VAN NIEUWSTADT, Utrecht (NL); Teunis VAN DE PEUT, Leusden (NL)

(73) Assignee: MAPPER LITHOGRAPHY IP B.V., Delft (NL)

(21) Appl. No.: 13/474,744

(22) Filed: May 18, 2012

Related U.S. Application Data
(60) Provisional application No. 61/487,465, filed on May 18, 2011.
(60) Provisional application No. 61/488,882, filed on May 23, 2011.

(51) Int. Cl. G03B 27/80; G06F 17/50

(52) U.S. Cl. CPC G03B 27/80; G06F 17/5081
USPC 355/46; 716/51

(57) ABSTRACT

The invention relates to a method for splitting a pattern for use in a multi-beamlet lithography apparatus. The method comprises providing an input pattern to be exposed onto a target surface by means of a plurality of beamlets of the multi-beamlet lithography apparatus. Within the input pattern first and second regions are identified. A first region is a region that is exclusively exposable by a single beamlet of the plurality of beamlets. A second region is a region that is exposable by more than one beamlet of the plurality of beamlets. On the basis of an assessment of the first and second regions it is determined what portion of the pattern is to be exposed by each beamlet.

### BACKGROUND OF THE INVENTION

1. Field of the Invention

The invention relates to a method for splitting a pattern for use in a multi-beamlet lithography apparatus. The invention further relates to a computer-readable medium arranged for performing, when executed by a processor, a method for splitting a pattern for use in a multi-beamlet lithography apparatus. Finally, the invention relates to a multi-beamlet lithography apparatus comprising a control unit provided with a processor for executing a method for splitting a pattern.

2. Description of the Related Art

Multi-beamlet lithography is an emerging technology to cope with the challenges of the semiconductor industry. In particular, initiatives are taken to develop charged particle multi-beamlet lithography systems that have a high volume throughput. In such systems a plurality of charged particle beamlets are used to transfer a pattern onto a target substrate surface.

Examples of such charged particle multi-beamlet lithography systems include systems as described in U.S. Pat. No. 6,958,804 and international patent application WO2009/127659, both in the name of the applicant. In these systems a continuous radiation source or a source operating at constant frequency is used in combination with suitable components to provide a plurality of charged particle beamlets. Pattern data are sent to a modulation device arranged to modulate the beamlets by electrostatic deflection. The modulated beamlets are then transferred to the target surface. Generally, during this transfer the diameter of the individual beamlets is reduced.

Patterning with a system as described needs a sophisticated control to enable accurate patterning. This is particularly the case if the beamlets follow a scanning trajectory covering adjacent areas on the target surface, also referred to as “stripes”, such that adjacent beamlets cover adjacent stripes. In such case, the pattern data sent to the modulation device to modulate these beamlets needs to be such that the entire area to be exposed is patterned without adjacent beamlets negatively influencing each other.

### BRIEF SUMMARY OF THE INVENTION

It is an object of the present invention to enable a suitable splitting of the pattern over the available beamlets with improved reliability without significant loss of throughput. For this purpose, an embodiment of the invention provides a method for splitting a pattern for use in a multi-beamlet lithography apparatus, the method comprising: providing an input pattern to be exposed onto a target surface by means of a plurality of beamlets of the multi-beamlet lithography apparatus; identifying first regions within the input pattern, each first region being a region that is exclusively exposable by a single beamlet of the plurality of beamlets; identifying second regions within the input pattern, each second region being a region that is exposable by more than one beamlet of the plurality of beamlets; and determining what portion of the pattern is to be exposed by each beamlet on the basis of an assessment of the first and second regions. This method allows the coverage of the surface area to be patterned such that features spanning over a second region appear as a single feature with sufficiently low distortion.

In some embodiments, the assessment of the first and second regions includes: identifying features to be exposed within the pattern; determining, for each feature, whether the features are located within a first region, a second region or both; deciding, for each feature, which beamlet exposes the features on the basis of the determined feature location. Upon determining that a feature is completely located in a first region, deciding may include assigning exposure of the feature to the beamlet configured to expose the first region. Upon determining that a feature is completely located in a second region, deciding may include assigning exposure of the feature to one of the beamlets configured to expose the second region. Upon determining that a feature is partly in a second region and partly in a first region of a single beamlet, deciding may include assigning exposure of the feature to the single beamlet. Upon determining that a feature is partly in a second region and partly in first regions of more than one beamlet, deciding includes assigning exposure of the feature parts in the first regions to the respective single beamlets and exposure of the feature part in the second region to one of the beamlets configured to expose the second region.

In some embodiments, upon determining that a feature is partly in a second region and partly in first regions of more than one beamlet, deciding includes assigning exposure of the feature parts in the first regions to the respective single beamlets and exposure of the feature part in the second region partially to one of the beamlets configured to expose the second region and partially to another one of the beamlets configured to expose the second region. The exposure assignment of the feature part within the second region may be based on the cross-sectional area of the feature parts in the first regions. The assignment of the feature part in the second region may then be such that the feature portion assigned to said one of the beamlets is substantially similar in size as the feature portion assigned to the other one of the beamlets.

In some embodiments, abovementioned method is performed in cycles with respect to two adjacent portions of the pattern to be exposed by two different beamlets, and the method, after being executed with respect to the pattern exposable by the first two beamlets under consideration, is applied on a pattern to be exposed by a first beamlet already considered in an earlier cycle of the method and a second beamlet configured to expose a portion of the pattern adjacent to the portion to be exposed by the first beamlet. The method may terminate after consideration of all beamlets.

Furthermore, some embodiments of the invention relate to a computer-readable medium arranged for performing, when executed by a processor, an embodiment of abovementioned method for splitting a pattern.

Finally, some embodiments of the invention relate to a lithography apparatus comprising: a beamlet generator for generating a plurality of beamlets; a beamlet modulator for patterning the beamlets to form modulated beamlets; a control unit for providing input for patterning to the beamlet modulator; and a beamlet projector for projecting the modulated beamlets onto a surface of a target; wherein the control unit is arranged to execute an embodiment of abovementioned method for splitting a pattern. The control unit may be arranged to receive a computer-readable data file, and the method for splitting may be applied on data in the data file. By executing the method of splitting in the lithography apparatus, the pattern design data received via the data file may be in a format that is also suitable for use on lithography apparatuses that are incapable of executing an embodiment of abovementioned method for splitting a pattern. Furthermore, the size of the data file will generally be less voluminous. In some embodiments, the pattern data file is provided with a tag indicating whether or not the method should be applied. The control unit is then arranged to detect the tag and to decide whether or not the method for splitting is to be executed on the basis of the content of the tag. Such tag provides more flexibility to a pattern designer, because it provides a possibility to overrule a setting in a lithography apparatus.

### BRIEF DESCRIPTION OF THE DRAWINGS

Various aspects of the invention will be further explained with reference to embodiments shown in the drawings wherein:

FIG. 1 schematically shows a charged particle multi-beamlet lithography system that may be used in embodiments of the inventions;

FIG. 2 is a conceptual diagram showing a lithography system;

FIG. 3 schematically shows a strategy for patterning a wafer with an electron optical system;

FIG. 4 schematically shows a further implementation of the writing strategy of FIG. 3;

FIG. 5 schematically shows a typical way of writing a pattern in accordance with the writing strategy of FIGS. 3 and 4;

FIG. 6 schematically shows an example of splitting a pattern in accordance to an embodiment of the invention;

FIGS. 7a-7c schematically show results of the pattern splitting in FIG. 6 per beamlet;

FIG. 8 schematically shows an example of a pattern before splitting;

FIGS. 9a-9b schematically show a possible outcome of splitting the pattern of FIG. 8 in accordance with an embodiment of the present invention.

### DESCRIPTION OF ILLUSTRATIVE EMBODIMENTS

The following is a description of various embodiments of the invention, given by way of example only and with reference to the figures. The figures are not drawn to scale and merely intended for illustrative purposes. Although reference is made to the term “beamlet”, this expression should not be interpreted as to exclude the term “beam”.

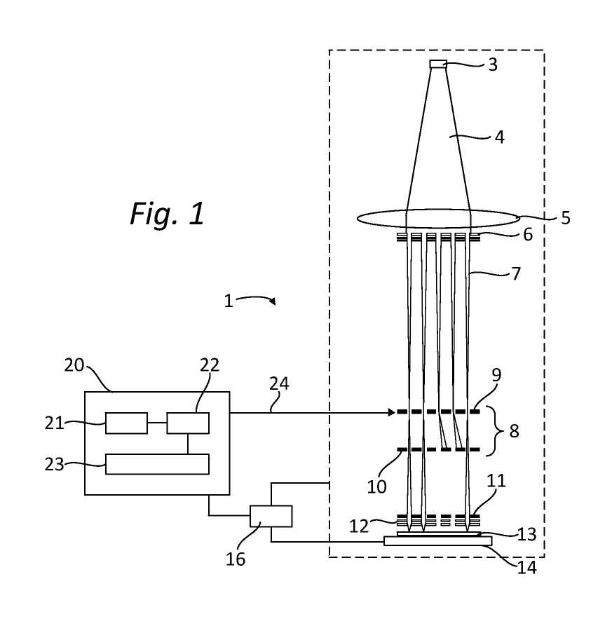

FIG. 1 shows a simplified schematic drawing of an embodiment of a charged particle multi-beamlet lithography system 1. The lithography system 1 suitably comprises a beamlet generator generating a plurality of beamlets, a beamlet modulator patterning the beamlets to form modulated beamlets, and a beamlet projector for projecting the modulated beamlets onto a surface of a target.

The beamlet generator typically comprises a source and at least one beam splitter. The source in FIG. 1 is an electron source 3 arranged to produce a substantially homogeneous, expanding electron beam 4. The beam energy of the electron beam 4 is preferably maintained relatively low in the range of about 1 to 10 keV. To achieve this, the acceleration voltage is preferably low, and the electron source 3 may be kept at a voltage between about −1 to −10 kV with respect to the target at ground potential, although other settings may also be used.

In FIG. 1 the electron beam 4 from the electron source 3 passes a collimator lens 5 for collimating the electron beam 4. The collimator lens 5 may be any type of collimating optical system. Before collimation, the electron beam 4 may pass a double octopole (not shown). Subsequently, the electron beam 4 impinges on a beam splitter, in the embodiment of FIG. 1 an aperture array 6. The aperture array 6 preferably comprises a plate having through-holes. The aperture array 6 is arranged to block part of the beam 4. Additionally, the array 6 allows a plurality of beamlets 7 to pass through so as to produce a plurality of parallel electron beamlets 7.

The lithography system 1 of FIG. 1 generates a large number of beamlets 7, preferably about 10,000 to 1,000,000 beamlets, although it is of course possible that more or less beamlets are generated. Note that other known methods may also be used to generate collimated beamlets. A second aperture array may be added in the system, so as to create subbeams from the electron beam 4 and to create electron beamlets 7 from the subbeam. This allows for manipulation of the subbeams further downstream, which turns out beneficial for the system operation, particularly when the number of beamlets in the system is 5,000 or more.

The beamlet modulator, denoted in FIG. 1 as modulation system 8, typically comprises a beamlet blanker array 9 comprising an arrangement of a plurality of blankers, and a beamlet stop array 10. The blankers are capable of deflecting one or more of the electron beamlets 7. In embodiments of the invention, the blankers are more specifically electrostatic deflectors provided with a first electrode, a second electrode and an aperture. The electrodes are then located on opposing sides of the aperture for generating an electric field across the aperture. Generally, one of the electrodes, e.g. the second electrode, is connected to ground potential to form a ground electrode.

To focus the electron beamlets 7 within the plane of the blanker array 9 the lithography system may further comprise a condenser lens array (not shown).

In the embodiment of FIG. 1, the beamlet stop array 10 comprises an array of apertures for allowing beamlets to pass through. The beamlet stop array 10, in its basic form, comprises a substrate provided with through-holes, typically round holes although other shapes may also be used. In some embodiments, the substrate of the beamlet stop array 10 is formed from a silicon wafer with a regularly spaced array of through-holes, and may be coated with a surface layer of a metal to prevent surface charging. In some further embodiments, the metal is of a type that does not form a native-oxide skin, such as CrMo.

The beamlet blanker array 9 and the beamlet stop array 10 operate together to block or let pass the beamlets 7. In some embodiments, the apertures of the beamlet stop array 10 are aligned with the apertures of the electrostatic deflectors in the beamlet blanker array 9. If beamlet blanker array 9 deflects a beamlet, it will not pass through the corresponding aperture in the beamlet stop array 10. Instead the beamlet will be blocked by the substrate of beamlet block array 10. If beamlet blanker array 9 does not deflect a beamlet, the beamlet will pass through the corresponding aperture in the beamlet stop array 10. In some alternative embodiments, cooperation between the beamlet blanker array 9 and the beamlet stop array 10 is such that deflection of a beamlet by a deflector in the blanker array 9 results in passage of the beamlet through the corresponding aperture in the beamlet stop array 10, while non-deflection results in blockage by the substrate of the beamlet stop array 10.

The modulation system 8 is arranged to add a pattern to the beamlets 7 on the basis of input provided by a control unit 20. The control unit 20 may comprise a data storage unit 21, a read out unit 22 and data converter 23. The control unit 20 may be located remote from the rest of the system, for instance outside the inner part of a clean room. The control system may further be connected to an actuator system 16. The actuator system is arranged for executing a relative movement of the electron-optical column represented by the dashed line in FIG. 1 and a target positioning system 14.

Modulated light beams 24 holding pattern data are transmitted to the beamlet blanker array 9 using optical fibers. More particularly, the modulated light beams 24 from optical fiber ends are projected on corresponding light sensitive elements located on the beamlet blanker array 9. The light sensitive elements may be arranged to convert the light signal into a different type of signal, for example an electric signal. A modulated light beam 24 carries a portion of the pattern data for controlling one or more blankers that are coupled to a corresponding light sensitive element. In some embodiments, the light beams 24 may, at least partially, be transferred towards the light sensitive elements by means of an optical waveguide.

The modulated beamlets coming out of the beamlet modulator are projected as a spot onto a target surface of a target 13 by the beamlet projector. The beamlet projector typically comprises a scanning deflector for scanning the modulated beamlets over the target surface and a projection lens system for focusing the modulated beamlets onto the target surface. These components may be present within a single end module.

Such end module is preferably constructed as an insertable, replaceable unit. The end module may thus comprise a deflector array 11, and a projection lens arrangement 12. The insertable, replaceable unit may also include the beamlet stop array 10 as discussed above with reference to the beamlet modulator. After leaving the end module, the beamlets 7 impinge on a target surface positioned at a target plane. For lithography applications, the target 13 usually comprises a wafer provided with a charged-particle sensitive layer or resist layer.

The deflector array 11 may take the form of a scanning deflector array arranged to deflect each beamlet 7 that passed the beamlet stop array 10. The deflector array 11 may comprise a plurality of electrostatic deflectors enabling the application of relatively small driving voltages. Although the deflector array 11 is drawn upstream of the projection lens arrangement 12, the deflector array 11 may also be positioned between the projection lens arrangement 12 and the target surface.

The projection lens arrangement 12 is arranged to focus the beamlets 7, before or after deflection by the deflector array 11. Preferably, the focusing results a geometric spot size of about 10 to 30 nanometers in diameter. In such preferred embodiment, the projection lens arrangement 12 is preferably arranged to provide a demagnification of about 100 to 500 times, most preferably as large as possible, e.g. in the range 300 to 500 times. In this preferred embodiment, the projection lens arrangement 12 may be advantageously located close to the target surface.

In some embodiments, a beam protector (not shown) may be located between the target surface and the projection lens arrangement 12. The beam protector may be a foil or a plate provided with a plurality of suitably positioned apertures. The beam protector is arranged to absorb the released resist particles before they can reach any of the sensitive elements in the lithography system 1.

The projection lens arrangement 12 may thus ensure that the spot size of a single pixel on the target surface is correct, while the deflector array 11 may ensure by appropriate scanning operations that the position of a pixel on the target surface is correct on a microscale. Particularly, the operation of the deflector array 11 is such that a pixel fits into a grid of pixels which ultimately constitutes the pattern on the target surface. It will be understood that the macroscale positioning of the pixel on the target surface is suitably enabled by a target positioning system 14.

Commonly, the target surface comprises a resist film on top of a substrate. Portions of the resist film will be chemically modified by application of the beamlets of charged particles, i.e. electrons. As a result thereof, the irradiated portion of the film will be more or less soluble in a developer, resulting in a resist pattern on a wafer. The resist pattern on the wafer can subsequently be transferred to an underlying layer, i.e. by implementation, etching and/or deposition steps as known in the art of semiconductor manufacturing. Evidently, if the irradiation is not uniform, the resist may not be developed in a uniform manner, leading to mistakes in the pattern. High-quality projection is therefore relevant to obtain a lithography system that provides a reproducible result. No difference in irradiation ought to result from deflection steps.

A design for an integrated circuit is typically represented in a computer-readable file. The GDS-II format, where GDS stands for Graphic Data Signal, is a database file format used to be the lithography industry standard for data exchange of integrated circuit or IC layout artwork. More recently, OASIS (Open Artwork System Interchange Standard) is adopted as a new industry standard. For a multi-beamlet lithography apparatus, such as a the apparatus discussed with reference to FIG. 1, the GDS-II or OASIS file is electronically processed to put it into a format suitable for controlling the lithography machine. The GDS-II or OASIS file is converted into a set of control signals for controlling the plurality of beamlets used in the lithography process. Hereafter, some embodiments may be discussed with reference to an OASIS-file only. However, it must be understood that the described embodiments also apply to other files, such as GDS-II files or files according to a standard derived from the GDS-II standard or OASIS-standard, and may also apply to files in a format in accordance with a future standard format, for example a successor of OASIS.

A preprocessing unit may be used to process the OASIS file to generate intermediate data for the multi-beamlet lithography apparatus. The intermediate data may be in a bitmap format, but may also have another format such as a description of areas in vector format.

Controlling the plurality of beamlets to enable a transfer of the design pattern presented on the computer-readable file onto the target surface of a substrate, such as a wafer, requires a splitting of the pattern over the beamlets that are used to transfer the pattern. Such splitting requires an assignment of (portions of) features to respective beamlets. Feature assignment is not trivial since each beamlet merely covers a small portion of the substrate, and pattern features may extend over an area that is not entirely covered by this beamlet. Hereafter, the area covered by a beamlet during a single pass over the substrate will be referred to as a stripe.

Patterning with a system as described needs a sophisticated control to enable accurate patterning. In particular, in case the beamlets follow a scanning trajectory covering adjacent areas on the target surface, also referred to as “stripes” such that adjacent beamlets cover adjacent stripes the pattern data sent to the modulation device to modulate these beamlets is preferably such that the entire area to be exposed is patterned without adjacent beamlets negatively influencing each other.

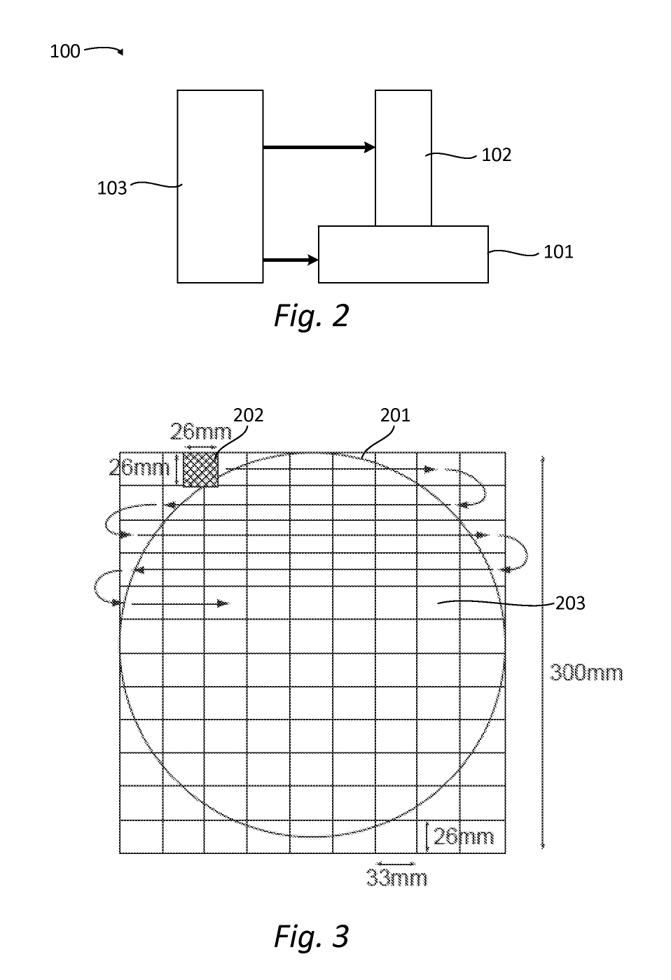

FIG. 2 is a conceptual diagram showing a lithography system 100, e.g. the charged particle lithography apparatus of FIG. 1. The lithography system is divided into three high level sub-systems: a wafer positioning system 101, an electron optical column 102, and a data path 103. The wafer positioning system 101 is configured to move the wafer under the electron optical column and is provided with control signals from the data path 103 to align the wafer with the electron beamlets within the electron-optical column 102. The data path 103 further provides control signals to the electron-optical column 102 to enable modulation of the electron beamlets in the electron-optical column 102 so that a predetermined pattern can be transferred from a computer-readable file in the data path 103 onto the wafer placed on the wafer positioning system 101 by the electron beamlets in the electron-optical column 102.

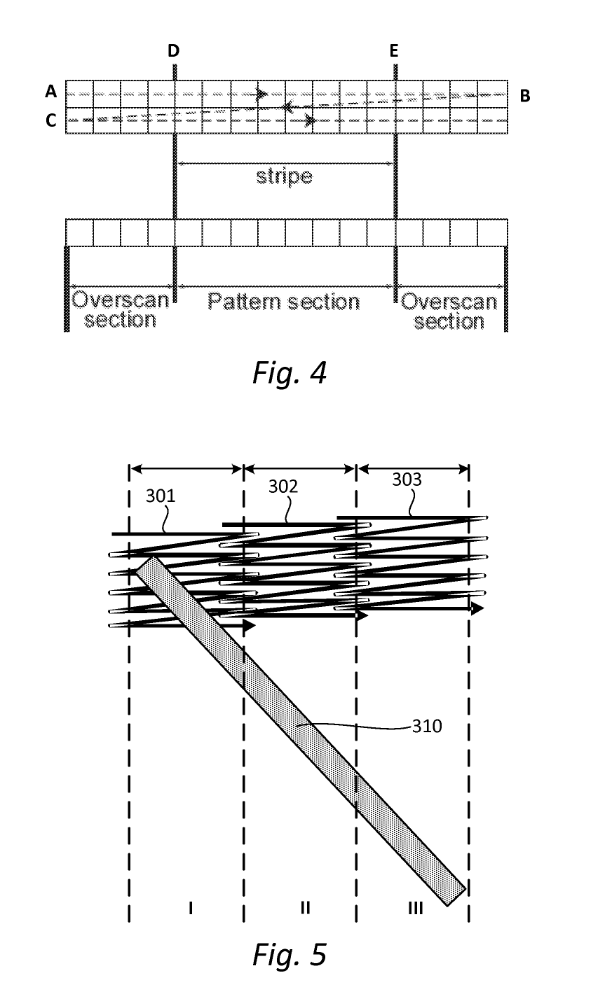

A writing strategy to accomplish an efficient and accurate transfer of a design pattern onto a wafer may follow a writing scheme as schematically shown in FIGS. 3 and 4.

FIG. 3 schematically shows a wafer 201 and a projection of the electron optical column, hereafter referred to as EO-slit 202, where EO stands for Electron Optics. Typical dimensions for the wafer would be a wafer having a 300 mm diameter, which corresponds to the current industry standard. The wafer 201 is divided into fixed size fields 203. A field 203 is defined as a rectangular area on a wafer 201, and typically has a maximum size of 26 mm×33 mm. A GDS-II or OASIS file typically describes the features of a field 203. Each field 203 may be processed to produced multiples integrated circuits (ICs), i.e. the layout for multiple chips may be written into a single field. With a size of 26 mm×33 mm there are 63 fields available on a single 300 mm wafer 201. Smaller fields 203 are possible and consequently more fields per wafer will be available.

In the exemplary embodiment of the lithography apparatus described below, the apparatus uses 13,000 beamlets to cover the field width 26 mm in a so-called mechanical scan direction (denoted by the arrows in FIG. 3). The 13,000 subbeams over a distance of 26 mm result in a so-called stripe with a width of 2 μm in the y-direction (perpendicular to the mechanical scan direction). The length of the stripe substantially equals the field in the x-direction.

As shown in FIG. 3, the wafer 201 is preferably patterned by the lithography apparatus in both backward and forward x-direction. The direction of writing in the y-direction (by a scanning deflector as discussed above) is usually in one direction.

When the size (width and/or length) of a field 203 is chosen to be smaller than the size of the EO-slit 202, then more fields can be placed on the wafer 201, but not all of the electron beamlets will be used to write on the wafer 201. The EO slit 202 will need to scan the wafer 201 more times and the overall throughput will decrease.

To arrange the exposure of a pattern using a multi-beamlet lithography apparatus, the pattern is split over the beamlets. Adjacent beamlets may then expose adjacent regions on the target surface to be exposed. Such exposure may use a scanning deflector as discussed with reference to the lithography apparatus of FIG. 1. The scanning deflector typically generates a triangular shape deflection signal for all beamlets in parallel. The deflection signal includes a scan phase and a fly-back phase, as shown in the schematic diagram in FIG. 4. During the scan phase, the deflection signal slowly moves the beamlets (when switched on) in the y-direction and the beamlet blanker array will switch the beamlet on and off according to the beamlet control signals. After the scan phase the flyback phase starts. During the fly-back phase, the beamlet is switched off and the deflection signal quickly moves the beamlet to the position where the next scan phase will start.

A scan line is the path of a beamlet on the surface of the wafer during the scan phase. Without special measures the scan line would not write exactly along the y-direction on the wafer, but will be slightly skewed with a small x-direction component as well because of the continuous stage movement in the x-direction. This error may be corrected by adding a small x-direction component to the deflection field to match the stage movement. This correction may be dealt with in the EO column so that the data path does not need to correct for this error. This x-direction component is small because the stage movement is slow in comparison to the y-direction deflection scan speed (a suitable x:y relative speed ratio may be 1:1000).

A scan line may be divided into three sections: a start overscan section, a pattern section, and an end overscan section. Beamlets are deflected along the y-direction. The distance in which the beamlets are deflected is typically wider than its stripe should write. Overscan provides space for shifting the positions where the beamlet can expose the wafer as will be discussed below. The width of an overscan section is typically about 10-30% of the stripe width. For example, in case of a stripe width of 2 μm an overscan of 0.5 μm (or 25%) would be suitable. The overscan sections of the scan line bit frame may hold bits that are not used for writing a pattern.

In FIG. 4 a scan line is depicted for the situation where only one beamlet is writing a stripe. The path of the beamlet during a deflection cycle is A-B-C. AB is the scan line movement during the scan phase, while BC is the fly-back during which the beamlet is switched off. The stripe borders are marked D and E.

During the entire scan line the beamlets are controlled by the lithography system. The overscan section allows for making small adjustments, for example to compensate for small positioning errors. Otherwise, in the overscan section the beamlets will typically be switched off. In the pattern section the beamlets are switched according to the features required to be written in the wafer field.

FIG. 5 schematically shows an arrangement used to write a pattern in a multi-beamlet lithography apparatus. In this exemplary arrangement 3 stripes I, II, and III are to be written by beamlets 301, 302, and 303 respectively. The stripe borders are represented by the dashed lines. Portions of the beamlet trajectories, which are similar in nature as the ones discussed with reference to FIG. 4, are also shown. The beamlets 301, 302, 303 expose a pattern including a pattern feature 310 on the target surface of a wafer.

The overscan area discussed with reference to FIG. 4 enables the possibility to compensate for stitching errors. Stitching relates to the tiling of regions exposed by adjacent beamlets exactly against each other. A small displacement of adjacent beamlets with respect to each other may decrease the accuracy of the pattern to be written. To reduce stitching errors, small adjustments, such as shifts, may be made in the pattern to be written by separate beamlets. In order to define the correct adjustment, rather complex measurements and calculations are needed. The inventors of the present invention realized that such small adjustments may be avoided, or at least the number of small adjustments may be reduced, by using the overscan area for a different purpose. In particular they developed a method for splitting the pattern based on this insight.

Such method for splitting a pattern may follow the following procedure. First, the input pattern to be exposed by a plurality of beamlets is provided. Within the pattern, two different regions are identified, i.e. first regions, also referred to as non-overlapping regions, and second regions, also referred to as overlapping regions. Finally, on the basis of an assessment of the non-overlapping and overlapping regions a determination is made what portion of the pattern is to be exposed by each beamlet.

A non-overlapping region is defined as a region that is exclusively exposable by a single beamlet of a plurality of beamlets that are generated in a multi-beamlet lithography apparatus. An overlapping region, on the other hand, is defined as a region that is exposable by more than one beamlet of such plurality of beamlets. In many arrangements overlapping regions are exposed by adjacent beamlets configured to expose adjacent “stripes”.

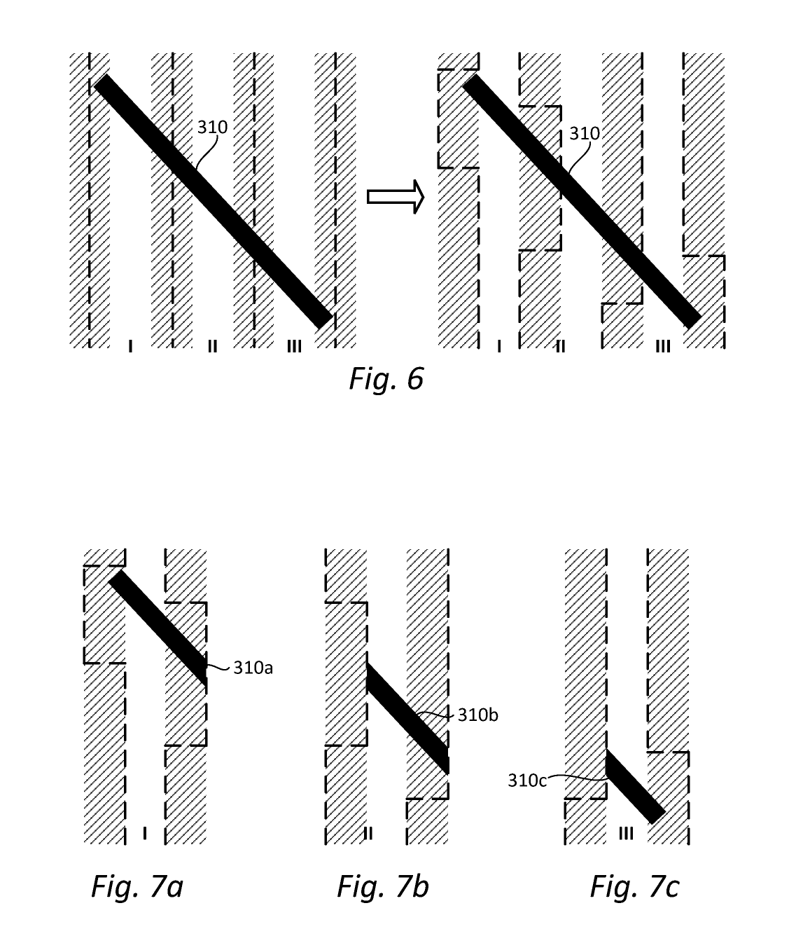

FIG. 6 schematically shows the pattern feature of FIG. 5 that is to be exposed via stripes I, II and III. In FIG. 6 the overlapping regions are dashed. The dashed lines show the border of the pattern written by the respective beamlets. Normally, as shown in FIG. 6 in the left panel, the pattern is equally divided between the lines such that the borders of the stripes written by the respective beamlets are straight lines dividing the overlapping regions in two equal portions. However, in accordance with the method for splitting a pattern as defined above, data portions may be assigned to the different beamlets such that different portions of the overlapping areas are exposed by different beamlets. A result of such rearrangement of pattern data is schematically shown in the right hand panel of FIG. 6.

As a result of this rearrangement, the beamlet configured for exposure of stripe I writes the feature in the area that it exclusively exposes as well as in the region that overlaps with the exposure area of the beamlet configured for exposure of stripe II (see FIG. 7a). As a result, the beamlet configured for the exposure of stripe II does not perform an exposure in this overlapping region. The beamlet configured for the exposure of stripe II, in its turn exposes the feature in its non-overlapping area as well as in the area has an overlap with the exposure area of the beamlet configured for exposure of stripe III (see FIG. 7b). Finally, the beamlet configured for exposure of stripe III writes the entire remainder of the feature, and does thus not expose the feature in the area that it shares with the beamlet configured for exposure of stripe II (see FIG. 7c).

Preferably the assessment of the non-overlapping and overlapping regions include the identification of features to be exposed within the pattern. For each feature, it may be determined whether the respective feature is located within a non-overlapping region, an overlapping region, or both. Subsequently, for each beamlet it is decided which beamlet exposes the features on the basis of the determined feature location. Note that the region determination and the decision which beamlet exposes the feature may be performed in a repetitive way where the number of beamlets being considered is lower than the total number of beamlets within the lithography apparatus.

Typically, the method evaluates two beamlets at the time. For example, with respect to obtaining the pattern split shown in FIGS. 7a-7c, the method may first be applied to the beamlets configured for exposing stripes I and II, which results in a decision as to which beamlet should expose the feature portion located in the overlapping region between these beamlets. Subsequently, the method would then be applied to the beamlets configured for exposing stripes II and III, which would lead to the decision as to which beamlet should expose the feature portion located in the overlapping regions between these two beamlets. Then the beamlet would be used with respect to the beamlet configured for exposing stripe III and its neighboring beamlet (not shown). The method is then applied until all features have been assigned to a specific beamlet of the plurality of beamlets within the multi-beamlet lithography apparatus.

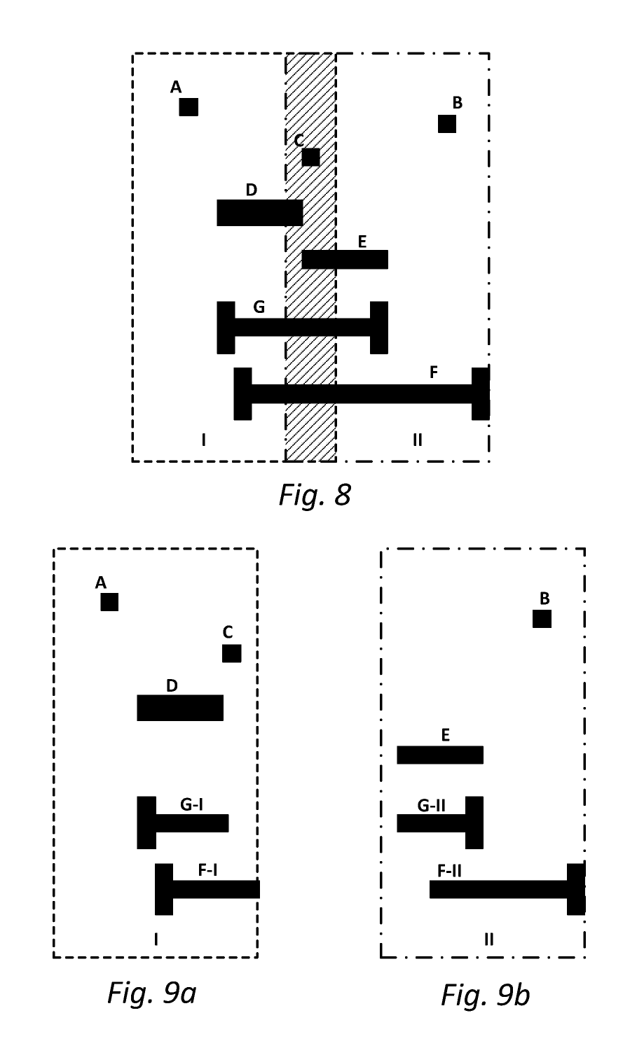

Preferably, the decision regarding the assignment of a pattern portion to a specific beamlet follows a predetermined algorithm. An example of (portions of) such algorithm is discussed with reference to FIG. 8. FIG. 8 schematically shows a pattern that is to be exposed by two adjacent beamlets. The beamlets are configured for writing stripes I and II respectively. Again the overlapping area that is shared by both beamlets corresponds to the dashed portion in the Figure. The features to be patterned are shown in black.

Upon determining that a feature is completely located in a non-overlapping region, the decision which beamlet should expose the feature includes assigning exposure of the feature to the beamlet configured to expose the non-overlapping region. Feature A is thus assigned to stripe I since it is exclusively exposable by the beamlet configured for exposing stripe I. Similarly, feature B is assigned to stripe II.

In case a feature is completely located in an overlapping region, preferably the feature is assigned to one of the beamlets configured to expose the overlapping region. Feature C is then thus assigned to either stripe I or stripe II. By deciding that only one beamlet exposes the feature in such case, typical stitching errors caused by a small deviation in beamlet position of the beamlets configured for patterning stripes I and II are avoided.

In case a portion of the feature is located in a non-overlapping region and another feature portion is located in an overlapping region other rules may apply.

For example, where a feature is partly located in an overlapping region and partly in a non-overlapping region of a single beamlet, deciding may include assigning exposure of the feature to the single beamlet. For example, feature D is partially located in the overlapping region whereas another portion is located in the region exclusively exposable by the beamlet configured for exposing stripe I. Following abovementioned rule, feature D would be exposed in its entirety by this beamlet. Similarly, feature E in FIG. 8 would be exposed in its entirety by the beamlet configured to expose stripe II. Again assigning an entire feature to a single beamlet has the advantage that there is no need for stitching feature portions together to form a complete feature. Consequently, stitching errors are avoided.

Yet other rules may apply In case a portion of the feature is located in an overlapping region and partly in non-overlapping regions of more than one beamlet. Generally, the feature portions in the non-overlapping regions are assigned to the respective beamlets that can expose this portion. With respect to the feature portion in the overlapping region different decisions may be made. For example, the feature portion in the overlapping region may be assigned in its entirety to one of the beamlets. This would be an acceptable solution in case the feature portion to be exposed by the beamlet not assigned to expose the feature portion in the overlapping region is sufficiently large. In FIG. 8, feature F is a feature that is divided in accordance with this rule (forming features F-I and F-II). The feature portion in the overlapping region is fully assigned to the beamlet configured for exposure of stripe I.

Alternatively, the feature portion in the overlapping region may be assigned in part to one of the beamlets configured to expose the overlapping region, while another part is assigned to the other one of the beamlets configured to expose the overlapping region. Such assignment of feature parts to different beamlets within the overlapping area may be based on the cross-sectional area of the feature portions in the non-overlapping regions of the respective beamlets. In this way, the minimum feature size that is exposed by the different beamlets may be set at a predetermined value.

In a specific embodiment, the assignment of a feature part in the second region is such that the feature portion assigned to both beamlets is substantially similar in size. An example of application of this rule is shown with respect to feature G in FIG. 8 (which is split in G-I and G-II respectively).

In case that the algorithm being used employs all rules discussed with reference to FIG. 8, the result of this algorithm with respect to the pattern shown in FIG. 8 would be that beamlet I exposes the features shown in FIG. 9a and beamlet II exposes the features shown in FIG. 9b.

Embodiments of the method of splitting a pattern may be executed at the time of putting data onto a pattern data file, such as a GDS-II file or an OASIS-file. However, such file may become very voluminous, which may be undesirable.

Alternatively, the method of splitting a pattern may be executed in a suitable control unit, for example control unit 20 located in the data path 103 of FIG. 2. The control unit may then comprise a processor arranged to execute a computer program. Such computer program may comprise elements that allow for performance of method of splitting the pattern. The computer program may be stored on a computer readable medium that can be loaded into the control unit. Some embodiments of a method of splitting a pattern may then be performed, when executed by the processor.

Executing the method of splitting may be an optional feature for a lithography apparatus. The design for an integrated circuit may be represented in a computer-readable data file, e.g. a GDS-II or OASIS-file, and be provided with a tag indicating whether or not the method should be applied.

The processor arranged to execute a computer program comprising elements that allow for performance of the method then thus executes the method under the condition that the tag in the data file indicates that the method should be applied. If the tag is absent, or indicates that the method should not be applied, the processor refrains from splitting the pattern.

The invention has been described by reference to certain embodiments discussed above. It will be recognized that these embodiments are susceptible to various modifications and alternative forms well known to those of skill in the art without departing from the spirit and scope of the invention. Accordingly, although specific embodiments have been described, these are examples only and are not limiting upon the scope of the invention, which is defined in the accompanying claims.

1. A method for splitting a pattern for use in a multi-beamlet lithography apparatus, the method comprising:
providing an input pattern to be exposed onto a target surface by means of a plurality of beamlets of the multi-beamlet lithography apparatus;
identifying first regions within the input pattern, each first region being a region that is exclusively exposable by a single beamlet of the plurality of beamlets
identifying second regions within the input pattern, each second region being a region that is exposable by more than one beamlet of the plurality of beamlets; and
determining what portion of the pattern is to be exposed by each beamlet on the basis of an assessment of the first and second regions.

2. The method of claim 1, wherein the assessment of the first and second regions includes:
identifying features to be exposed within the pattern;
determining, for each feature, whether the features are located within a first region, a second region or both;
deciding, for each feature, which beamlet exposes the features on the basis of the determined feature location.

3. The method of claim 2, wherein, upon determining that a feature is completely located in a first region, deciding includes assigning exposure of the feature to the beamlet configured to expose said first region.

4. The method of claim 2, wherein, upon determining that a feature is completely located in a second region, deciding includes assigning exposure of the feature to one of the beamlets configured to expose said second region.

5. The method of claim 2, wherein, upon determining that a feature is partly in a second region and partly in a first region of a single beamlet, deciding includes assigning exposure of the feature to said single beamlet.

6. The method of claim 2, wherein, upon determining that a feature is partly in a second region and partly in first regions of more than one beamlet, deciding includes assigning exposure of the feature parts in the first regions to the respective single beamlets and exposure of the feature part in the second region to one of the beamlets configured to expose said second region.

7. The method of claim 2, wherein, upon determining that a feature is partly in a second region and partly in first regions of more than one beamlet, deciding includes assigning exposure of the feature parts in the first regions to the respective single beamlets and exposure of the feature part in the second region partially to one of the beamlets configured to expose said second region and partially to another one of the beamlets configured to expose said second region.

8. The method of claim 7, wherein said exposure assignment of the feature part within the second region is based on the cross-sectional area of the feature parts in the first regions.

9. The method of claim 8, wherein the assignment of the feature part in the second region is such that the feature portion assigned to the said one of the beamlets is substantially similar in size as the feature portion assigned to the other one of the beamlets.

10. The method of claim 1, wherein the method is performed in cycles with respect to two adjacent portions of the pattern to be exposed by two different beamlets, and the method, after being executed with respect to the pattern exposable by the first two beamlets under consideration, is applied on a pattern to be exposed by a first beamlet already considered in an earlier cycle of the method and a second beamlet configured to expose a portion of the pattern adjacent to the portion to be exposed by the first beamlet.

11. The method of claim 10, wherein the method is terminated after consideration of all beamlets.

12. A computer-readable medium arranged for performing, when executed by a processor, the method for splitting a pattern according to claim 1.

13. A lithography apparatus comprising:
a beamlet generator for generating a plurality of beamlets;
a beamlet modulator for patterning the beamlets to form modulated beamlets;
a control unit for providing input for patterning to the beamlet modulator; and
a beamlet projector for projecting the modulated beamlets onto a surface of a target;
wherein the control unit is arranged to execute the method for splitting a pattern according to claim 1.

14. The lithography apparatus of claim 13, wherein the control unit is arranged to receive a computer-readable data file, and the method for splitting a pattern is applied on data in the data file.

15. The lithography apparatus of claim 14, wherein the pattern data file is provided with a tag indicating whether or not the method should be applied, and wherein the control unit is arranged to detect the tag and to decide whether or not the method for splitting a pattern is to be executed on the basis of the content of the tag.
